(19) United States
(12) Patent Application Publication
(10) Pub. No.: US 2004/0263622 A1
(43) Pub. Date: Dec. 30, 2004

(54) Plural-receptor, plural-mode, surveillance imaging system

(76) Inventors: Michael R. Dennis, Scappose, OR (US); David M. Dennis, Scappoose, OR (US)

Correspondence Address: ROBERT D. VARITZ, P.C., 2007 S.E. Grant Street, Portland, OR, 97201, US

(21) Appl. No.: 10/633,050

(22) Filed: Jul. 31, 2003

Related U.S. Application Data
(60) Provisional application No. 60/484,264, filed on Jun. 30, 2003.

(51) Int. Cl. H04N 7/18

(52) U.S. Cl. 348/143

(57) ABSTRACT

An multi-information-character imaging surveillance system and methodology which employs an optical, daytime, color video imager, an optical, nighttime, light-intensified, black-and-white video imager, a thermal imager, and housing structure closely containing each of said imagers as an assembly in respective, cooperative, relative positions and conditions wherein they share a substantially common point of view. Each of the three imagers has an imaging axis, and the three imaging axes are oriented whereby they are substantially bore-sight aligned at infinity. Further included and employed is computer-controllable, motor-actuatable drive structure which is operatively and drivingly connected to the housing structure, and thus to the contained imager assembly, for producing unitized, selective and controlled surveillance-motion tracking via generally horizontal panning and general vertical tilting motions.

### CROSS-REFERENCE TO RELATED APPLICATION

This application claims priority to U.S. Provisional Patent Application Serial No. 60/484, 264 filed Jun. 30, 2003, for “Surveillance Imaging System and Methodology”. The entirety of this priority patent application is hereby incorporated herein by reference.

### BACKGROUND AND SUMMARY OF THE INVENTION

This invention pertains to surveillance imaging apparatus and methodology. In particular, it relates to a multi-information-character, surveillance imaging system and methodology which employs three, commonly “aimed”, motion-unitized imagers, including (a) an optical, daytime color video imager, (b) an optical, nighttime, light-intensified, black-and-white imager, and (c) a thermal imager, all contained within a compact, unitizing housing. For the purpose of illustration herein, a preferred and best mode embodiment of, and manner of practicing, the invention, are described in the setting of an overall surveillance imaging system which employs other cooperative components and modalities of control and operation.

There are many applications wherein it is desirable to provide imaging surveillance capabilities that are functional under a wide range of circumstances, including full daytime surveillance, very dark nighttime scene surveillance, and, at any time of day, thermal surveillance. Each of these three approaches to imaging surveillance is useful in providing different, specific kinds of information, and it is especially desirable, in many applications, to have the capability of comparing, either by time sequencing, or in side-by-side simultaneous displaying, viewable surveillance imagery drawn from different ones of these several, generally above-mentioned environmental conditions. For example, during daytime surveillance, the visible spectrum may yield quite a bit of information about a scene being viewed, but will not necessarily reveal information that can be thermally displayed regarding the same “scene”, which thermal information may be very relevant to surveillance issues. By providing a system in which both of these kinds of surveillance information can be viewed in any one of several comparative and augmenting modes, quite a bit of important information not available just by the use of just one of these two modes becomes accessible.

Considering another illustrative situation wherein different surveillance imaging modes may be important, consider those conditions which exist typically during times of day near dawn, and near and just after sunset, when it might be desirable to be able to view a scene from several different imaging points of view, such as from a daylight, color, video imager, a nighttime, light-intensified imager, and a thermal imager. Deceptive lighting conditions which typically exist during these times of day, can become more readily decipherable if one can, for example, sequentially view input information derived alternatively from a daytime color video imager and a nighttime, light-intensified imager. It is also extremely useful to have available the opportunity to view the very same scene condition with a thermal imager for the acquisition of additional comparative surveillance information.

At nighttime, it is important to be able, in many instances, to have available both thermal and nighttime light-intensified surveillance imagery, and it is important with regard to this comparative surveillance mode of operation that a surveillance observer be presented with visual information which is easy and non-fatiguing to view. This last comment is directed to the issue of presenting light-intensified nighttime imagery which conventionally is presented in the form of a quite intense green-spectrum screen image which is harsh and very fatiguing to view, and as a consequence, challenging with respect to a user whose point of view shifts back-and-forth between imagery presented by a thermal imager and that presented by such a conventional intensified-light nighttime imager. Such a circumstance would be greatly improved under circumstances where a nighttime light-intensified image has a black-and-white achromatic characteristic which makes it, in terms of how it appears on a video display screen, very much like black-and-white thermal imagery.

The system and methodology of the present invention uniquely address all of these considerations in a very practical, reliable, and relatively simple manner. The various features and advantages which are offered by the invention will now become more fully apparent as the description which follows is read in conjunction with the accompanying drawings.

### DESCRIPTION OF THE DRAWINGS

FIG. 1A is a simplified and stylized isometric view of a multi-imager surveillance system which employs plural-mode, plural receptors (imagers) organized and operable in accordance with a preferred and best mode embodiment of, and manner of practicing, the present invention. At the right side of this figure, fragmentary dash-double-dot lines illustrate one modified form of the system which is pictured centrally in the figure.

FIG. 1B is a simplified block/schematic illustration of another modified form of the system centrally pictured in FIG. 1A.

FIG. 2 is a fragmentary view of that portion of the system illustrated in FIG. 1 which features a housing-enclosed assembly of plural (three) imagers, commonly bore-sighted at infinity, and unified for linked panning and tilting surveillance-tracking motions in accordance with the present invention.

FIG. 3 pictures a computer-generated display on a user-interface touch screen in a controller in the system pictured in FIG. 1, showing a typical screen appearance for a situation where, co-active in the system, are a daytime color imager and a thermal imager. FIG. 3 illustrates the various control functions which are furnished to manage these imagers, and the assembly of which they are a part, in accordance with practice of the invention.

FIGS. 4 and 5 are actual photographic images of a thermal image and a daytime image, respectively, provided simultaneously on a pair of side-by-side video display screen devices in a manner which is related to the touch screen control situation pictured in FIG. 3.

FIG. 6 is similar to FIG. 3, except that here what is shown is a typical touch-screen display under circumstances where, co-active in the system of the invention, are a light-intensified, black-and-white, nighttime imager, and a thermal imager.

FIGS. 7 and 8 have essentially the same characteristic relationship to FIG. 6 as do FIGS. 4 and 5 to FIG. 3. Very specifically, FIG. 7 is an actual photograph of a black-and-white, light-intensified nighttime image presented on a display screen in accordance with practice of the present invention, simultaneous with a companion thermal image of the same scene, pictured in FIG. 8, and presented on a video display screen connected to receive output video information from the thermal imager in the system of FIG. 1A.

FIG. 9 is similar to FIGS. 3 and 6, except that here what is shown is a presentation on the mentioned user-interface touch screen showing a condition where only the thermal imager in the system of FIG. 1A is currently active.

### DETAILED DESCRIPTION OF THE INVENTION

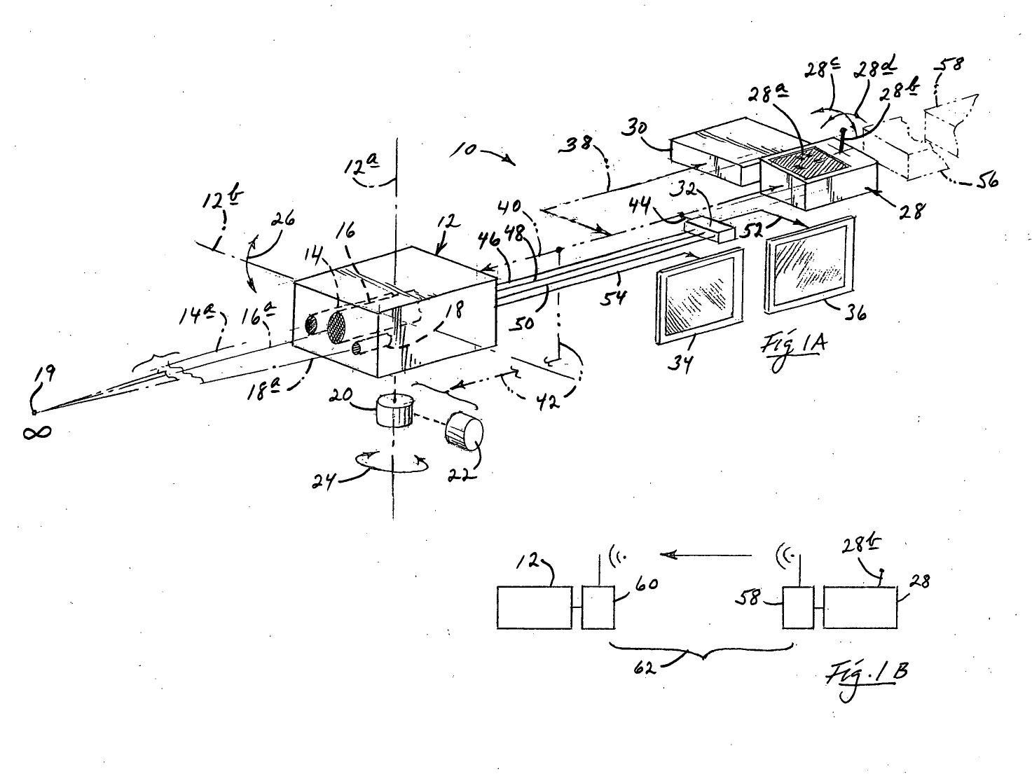

Turning attention now to the drawings, and referring first of all to FIG. 1A, indicated generally at 10 is a multi-information character surveillance imaging system which includes a plural-mode assembly of three imagers unified in a common housing—and all constructed in accordance with the preferred and best mode embodiment of the present invention. Included in system 10 are a housing structure, or housing, 12 which is appropriately environmentally sealed, and which contains the just-mentioned plural-imager assembly including (a) an optical, light-intensified, black-and-white nighttime imager 14, (b) a thermal imager 16, and (c) an optical, daytime color video imager 18. These three imagers are also referred to herein as scene-imaging instrumentalities.

Drivingly connected to housing 12, which housing is suitably supported on a stand (not shown), are two computer-controllable electrical motors 20, 22, also referred to herein as motor-actuatable drive structure. Motor 20 is selectively operable by an operator/user of system 10 to cause housing 12 (and the contained assembly of imagers) to swing as a unit reversibly back-and-forth angularly (in yaw or panning motion) about a generally upright axis shown at 12a. Such swinging motion is generally indicated in FIG. 1A by double-ended, curved arrow 24 in this figure. Similarly, motor 22 is likewise selectively operable to cause reversible up-and-down angular tilting (a pitch motion) of housing 12, and of the contained imagers, about a generally horizontal axis 12b. This motion is indicated by double-ended, curved arrow 26 in FIG. 1A. Suitably interposed housing 12 and the mentioned (but not illustrated) stand, is conventional motion/articulating structure (also not shown) which enablingly supports housing 12 on the stand for such motions.

Each of imagers 14, 16, 18 is provided with suitable computer-controllable apparatus for effecting selectable changes in various parameters, such as magnification, field of view, focus, and any other appropriate operational parameters. The exact parameters which are associated controllably with each of imagers 14, 16, 18 do not form any part of the present invention.

Further describing generally the assembly, or arrangement, of the three imagers in accordance with this invention, imagers 14, 16, 18 are commonly bore-sighted, or bore-sight aligned, along their respective optical (or imaging) axes 14a, 16a, 18a, at infinity, which is represented schematically at 19 on the left side of FIG. 1A. The terminology “commonly bore-sighted” refers to the fact that, effectively at infinity, all three imagers are aimed substantially exactly at the same point in space. An important consequence of this common, or matching, bore-sight alignment is that all of these different-mode imagers are always effectively looking at a surveillance scene with a substantially matching point of view, though not necessarily, as will be seen with the same field of view. This important shared alignment leads significantly to highly informative, comparative, surveillance observation and interpretation.

Further included in system 10 are (a) a user-operable controller 28 having a touch-sensitive screen 28a, and a multi-axis, manual, mechanical joystick shown at 28b, (b) an appropriate computer 30, (c) video signal switching structure 32, and (d) a pair of conventional video screen display devices 34, 36, also referred to herein as visual display devices.

Within controller 28, touch screen 28a, through appropriate programming which is managed by computer 30, which computer is appropriately operatively coupled (not specifically shown) to controller 28, enables a user to select and control, among other things, the various operating parameters of imagers 14, 16, 18. Such control includes, for example, switching these imagers into and out of operation, adjusting focus, establishing magnification and thus field of view, and making changes in any other appropriate parameters. Manual joystick 28b is rockable in manners generally indicated by double-ended, curved arrows 28c, 28d to effect housing pitch (tilting) and yaw (panning) angular motions, respectively, of the housing and imager assembly via motors 22, 20, respectively. While a manual joystick is specifically shown in controller 28, it should be understood that joystick functionality may, if desired, be provided in a virtual sense by way of an appropriate touchable screen image provided on touch screen 28a under the control of computer 30.

Appropriately associated computer-active control lines 38, 40, 42, 44 extend operatively as shown between housing 12 (and the imagers contained therein), motors 20, 22, controller 28, computer 30, and switching structure 32. It is through these lines that control is exercised, via controller 28 and the operation of computer 30, over the imagers' parameter adjustments, the motor operations, and the operations of switching structure 32. Three additional lines 46, 48, 40 are shown extending between housing 12 and switching structure 32, and another line 52 is shown interconnecting structure 32 and display device 36. Still another line 54 is shown interconnecting housing 12 and display device 34.

In most applications, it is especially convenient to have available two display devices incorporated into system 10 as illustrated. With this arrangement, daytime and nighttime images presented selectively on the screen in display device 36 can be cross-related instantly to comparable thermal imagery presented dedicatedly on the screen in display device 34. In other applications, a user may wish to have available only a single active display device, such as device 36, on whose screen outputs from each of the three imagers may be selectively and exclusively presented at a given time. In addition to these possibilities, and at those certain beginning and ending times of daylight wherein both imagery from a daylight color camera and imagery from an intensified, black-and-white nighttime camera may be important to view, these two kinds of images can be “compared” with one another simply by switching back and forth between these two sources of display information, so as to place their respective output displays alternately on the screen in display device 36.

Lines 46, 48, 50 carry video output signals from imagers 14, 16, 18, respectively, to switching structure 32. Under the control of touch screen 28a and computer 30, a user/operator can selectively send a signal from any one of these three imagers over line 52 for display of an image on display device 36. Thus display device 36 can selectively display an image either from nighttime imager 14, from thermal imager 16, or from daytime imager 18. Display device 36 is also referred to herein as an achromatic video-image-display output structure. Line 54 dedicatedly delivers video output image information from thermal imager 16 directly to video display device 34.

Still considering constructional features in system 10, nighttime, black-and-white imager 14 is effectively made up of an input lens structure, a light intensifier, and a black-and-white, single-CCD-device video camera. Because the specific construction of imager 14 does not form any part of the present invention, this make up of imager 14 is simply described verbally herein, but not illustrated in the drawings.

With further reference to FIG. 1A, shown in dash-double-dot, fragmentary lines 56, 58 at the right side of this figure are portions of two additional controllers which are like controller 28. These additional controllers can be employed, in accordance with one modification of system 10, to offer places for user control that are distributed to different locations. While two such additional controllers are shown at 56, 58, it should be understood that any number of additional controllers, including only a single additional controller, may be employed advantageously if desired.

Still considering systemic modifications that can be made, yet another modification is illustrated generally in FIG. 1B. Here, in very simplified form, a controller 28 is shown operatively connected to a wireless transmitting device 58 which is designed to transmit control information from controller 28 to operable equipment associated with imager housing 12, including all of the imagers provided therein, and the pitch and yaw drive motors. Information transmitted by device 58 is received by an appropriate receiver which is shown at 60 in FIG. 1B, which receiver is suitably operatively connected to all of the controllable apparatus associated with housing 12. The wireless transmission medium employed may be a radio system, a wireless telephone system, the Internet, and so on. A bracket 62 provided in FIG. 1B is presented to emphasize the operative connectedness which exists between blocks 58, 60 in FIG. 1B.

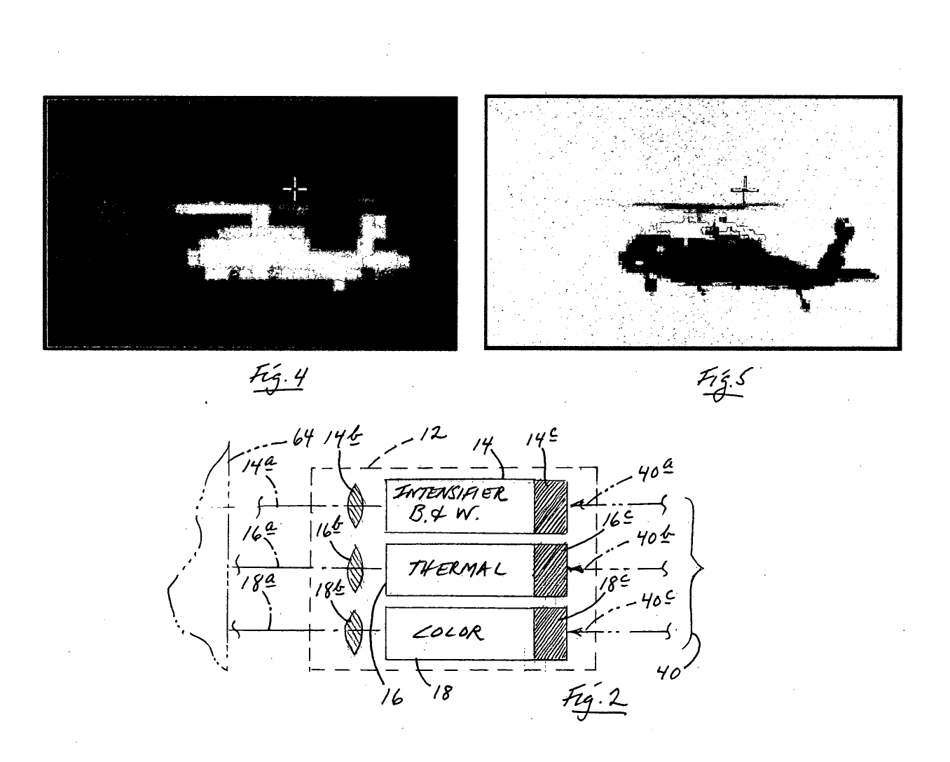

Turning attention now to FIG. 2-8, inclusive, in the drawings, in FIG. 2 imagers 14, 16, 18 are shown aimed toward a defined field of view 64. Controllable optical lens structures 14b, 16b, 18b are appropriately furnished for, and as parts of, imagers 14, 16, 18, respectively, along with other parameter adjustment structures (represented by shaded blocks) 14c, 16c, 18c for imagers 14, 16, 18, respectively. Previously mentioned control line 40 is seen in FIG. 2 to include three sub-lines 40a, 40b, 40c which connect directly with parameter-adjustment structures 14c, 16c, 18c, respectively. It is through these sub-lines that various parameter controls are activated under the influence of controller 28 and computer 30.

With the arrangement and organization thus far described herein respecting the compact assembly of three different imagers, 14, 16, 18 within the confines of housing 12, and with these three, different-mode imagers organized so that their optical axes are bore-sighted at infinity as mentioned above, these three imagers, with operation of the system, act in substantial unity both with respect to the particular point of view which is taken during any particular moment in time, and with respect to the fact that any motion introduced into housing 12 to shift field of view results in simultaneous and like coordinated motion of all three imagers together. This situation thus assures reliability in the presentation of different-mode images for relatively easy comparative observation and decision making regarding surveillance activities. This situation, thus, is a key contribution to the art made by the present invention.

FIGS. 3, 6, and 9 show three different views of imagery which may be presented on touch screen 28a. In FIG. 3, two of the imagers are activated and they are the daytime imager and the thermal imager. Various parameter control capabilities and opportunities, as can be seen, are made available by the presentation, on this screen view, of virtual interaction buttons.

FIG. 6 is similar to FIG. 3, except that here what one sees is that again there are just two of the three imagers active with regard to display creation, and these two imagers are the nighttime imager and the thermal imager. Again, specific parameter control opportunities are represented by virtual interaction buttons presented on this screen.

FIG. 9 is similar to FIGS. 3 and 6 except that here what is shown is a condition where only the thermal imager is active.

It will be evident to those generally skilled in the art that the specific appearance of touch screen options in accordance with practice of this invention can look many different ways, and the specific way that a look takes place on screen 28a is not specifically any part of the present invention. The invention thus offers a great deal of user/designer flexibility with regard to selection of a specific kind of interface.

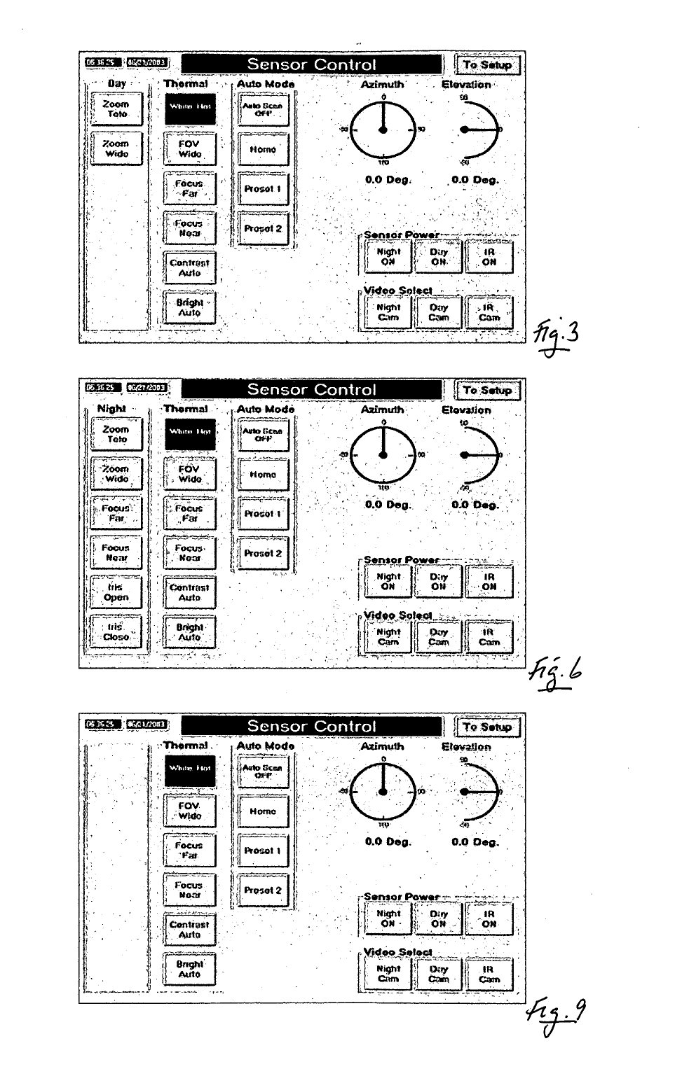

FIGS. 4, 5, 7 and 8, as mentioned earlier, are actual photographic screen shots of displays illustrating the system of this invention in use. Very specifically, FIGS. 4 and 5 illustrate imaging of a flying helicopter, with FIG. 4 showing a display created from the activity of the thermal imager, and FIG. 5 showing the same point-of-view display as derived from the daytime color imager. Views such as those shown in FIGS. 4 and 5 represent views that would appear on display devices 34, 36, respectively, when a user has selected, for simultaneous display, a thermal image and a daytime color video image.

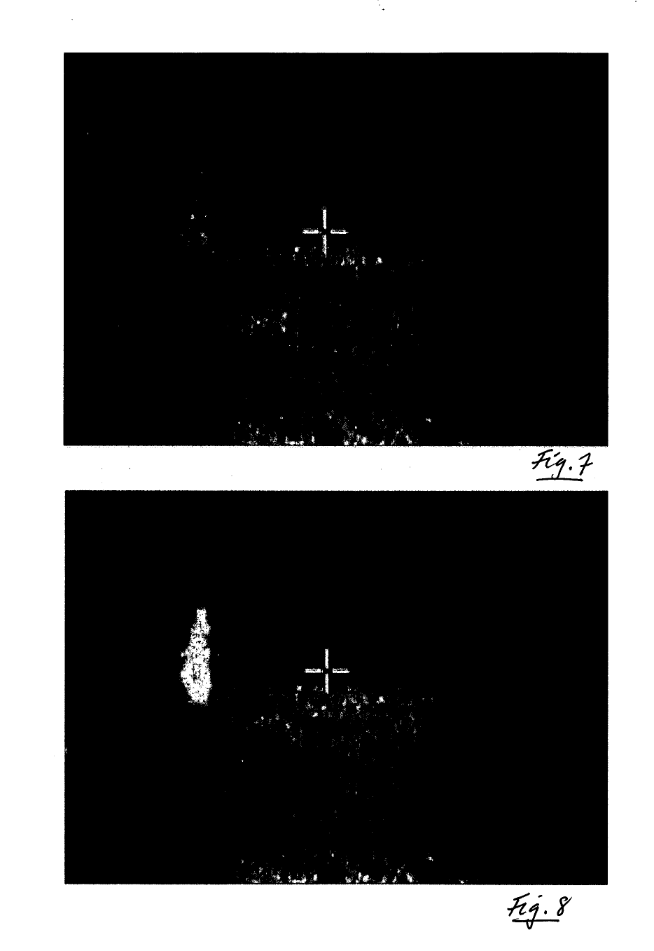

FIGS. 7 and 8 show a similar kind of comparison, with FIG. 7 illustrating a nighttime, intensified light black-and-white image derived from imager 14, and with FIG. 8 showing the comparable view created simultaneously by the thermal imager. Views like those shown in FIGS. 7 and 8 are typical of views that might appear on the screens in display devices 36, 34, respectively, when a user has selected to see output imagery simultaneously derived from both the thermal imager and the nighttime, black-and-white, intensified light imager.

Thus there is proposed by the present invention a unique multi-information-character surveillance imaging system which includes an optical daytime color video imager, an optical nighttime light-intensified black-and-white video imager, and a thermal imager, all compactly arranged as an assembly within a common housing structure. These imagers have optical axes which are bore-sight aligned at infinity, and all of these imagers can be panned and tilted as a unit by panning and tilting the containing housing structure.

One way of thinking, now, about the novel methodology offered by the present invention is to describe it as including the steps of (1) furnishing plural different scene-imaging instrumentalities, including a daytime color imager, a nighttime light-intensified black-and-white imager, and a thermal imager, (2) assembling such imagers in a closely formed arrangement within a common containing housing in a manner whereby the imagers share a substantially common point of view with their respective imaging axes substantially bore-sight aligned at infinity, and then (3) selectively, including plurally and simultaneously, using these different imagers in such an assembly to view a chosen surveillance scene.

Thus, while a preferred embodiment (and certain modifications) of, and manner of practicing, the present invention have been described herein, it is appreciated that variations and modifications may be made without departing from the sprit of the invention.

We claim:

1. A multi-information-character surveillance imaging system comprising
an optical, daytime, color video imager having an imaging axis,
an optical, nighttime, light-intensified, black-and-white video imager having an imaging axis,
a thermal imager having an imaging axis, and
housing structure closely containing each of said imagers as an assembly in respective, cooperative, relative positions and conditions wherein they share a substantially common point of view, with said three imaging axes oriented whereby they are substantially bore-sight aligned at infinity.

2. The system of claim 1 which further includes computer-controllable, motor-actuatable drive structure operatively and drivingly connected to said housing structure and contained imager assembly for producing selective and controlled surveillance-motion tracking via generally horizontal panning and general vertical tilting motions.

3. A multi-information-character surveillance imaging method comprising
furnishing plural different scene-imaging instrumentalities, including (a) an optical, daytime, color video imager, (b) an optical, nighttime, light-intensified, black-and-white video imager, and (c) a thermal imager, with each of these imagers possessing a respective imaging axis,
assembling such imagers in a closely formed arrangement within a common, containing housing structure in a manner whereby the imagers share a substantially common point of view, with their respective imaging axes substantially bore-sight aligned at infinity, and
selectively, including plurally and simultaneously, using these different imagers in such assembly to view a chosen scene.

4. The method of claim 3 which further comprises preparing the housing-structure-contained imager assembly for computer-controllable, motor-driven surveillance-tracking motions, including generally horizontal panning and generally vertical tilting motions, and as part of said preparing, drivingly connecting the thus-contained imager assembly operatively to a user-operable computer.
